(19) United States
(12) Patent Application Publication
(10) Pub. No.: US 2004/0049618 A1
(43) Pub. Date: Mar. 11, 2004

(54) Configuration of private devices and device functions

(76) Inventors: Mark A. Schmisseur, Phoenix, AZ (US); Marc A. Goldschmidt, Scottsdale, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/238,303

(22) Filed: Sep. 10, 2002

(51) Int. Cl. G06F 13/00

(52) U.S. Cl. 710/104

(57) ABSTRACT

Disclosed are a system and method of configuring a device or device function to claim bus transactions. A host processing system may execute an enumeration procedure to configure one or more devices coupled to a data bus. At least one of a device and a device function may be concealed from the host processing system during the enumeration procedure. The concealed device or device function may be configured to claim bus transaction requests initiated by an entity independently of the host processing system.

### RELATED APPLICATIONS

The subject matter disclosed herein relates to U.S. patent application Ser. No. 09/472,502 filed on Dec. 27, 1999, and U.S. patent application Ser. No. 09/954,129, filed on Sep. 14, 2001.

### BACKGROUND

1. Field

The subject matter disclosed herein relates to communication among devices in a processing platform. In particular, the subject matter disclosed herein relates to communication among devices according to a data bus protocol.

2. Information

Processing platforms typically comprise a host processing system coupled to one or more peripheral devices by a data bus. In a processing platform providing data storage resources for networked clients, such a peripheral device may enable communication with a redundant array of inexpensive disks (RAID) to provide a robust data storage system. Such a processing platform typically comprises an input/output (I/O) processor coupled to a host processing system by a data bus. The I/O processor may then control access to storage media through one or more I/O channels providing the data storage resources to networked clients.

The I/O channels providing access to the data storage resources may comprise I/O devices coupled to a data bus in the processing platform. While such a data bus may enable host processing system to communicate with such an I/O device coupled to the data bus, an I/O processor that is to control access to the I/O channel may conceal the entire I/O device or certain functions of the I/O device from the host processing system. This enables the I/O processor to exercise exclusive control over the concealed devices and functions of devices.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic of a processing platform according to an embodiment of the present invention.

FIG. 2 shows a schematic diagram of a processing platform according to an alternative embodiment of the present invention.

FIG. 3 shows flow diagram illustrating a process to configure a concealed device or device function according to an embodiment of the processing platform shown in either FIG. 1 or 2.

FIG. 4 shows a diagram illustrating a format of a configuration header according to an embodiment of the process illustrated in FIG. 3.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a machine readable medium may comprise one or more storage devices for storing machine-readable instructions or data. Such storage devices may comprise storage media such as, for example, optical, magnetic or semiconductor storage media. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and embodiments of the present invention are not limited in these respects.

A “processing system” as discussed herein relates to a combination of hardware and software resources for accomplishing computational tasks. A “host processing system” relates to a processing system which may be adapted to communicate with a “peripheral device.” For example, a peripheral device may provide inputs to or receive outputs from an application process hosted on the host processing system. However, these are merely examples of a processing system, host processing system and peripheral device, and embodiments of the present invention are not limited in these respects.

A “data bus” as referred to herein relates to circuitry for transmitting data between devices. For example, a data bus may transmit data between a host processing system and a peripheral device. Also, a data bus may transmit data between two peripheral devices. A data bus may be formed according to the Peripheral Components Interconnect (PCI) Local Bus Specification, Rev. 2.3, Mar. 29, 2002 (hereinafter the PCI Local Bus Specification) or the PCI-X 2.0 Protocol Specification (hereinafter the PCI-X 2.0 Protocol Specification). Alternatively, a data bus may be formed to couple an “endpoint” device and a host processing system through a “root complex” as provided in a PCI Express environment described in the PCI Express Base Specification Rev. 1.0, Jul. 16, 2002 (hereinafter the “PCI Express Specification”). A data bus may also be formed to couple two endpoint devices. However, these are merely examples of a data bus and embodiments of the present invention are not limited in these respects. A “bus transaction” as referred to herein relates to an interaction between devices coupled in a data bus structure wherein one device transmits data addressed to the other device through the data bus structure. However, this is merely an example of a bus transaction and embodiments of the present invention are not limited in this respect.

A data bus may be coupled to one or more devices at “data interfaces” associated with addresses on the data bus. Such a data interface may comprise a physical connection to couple a device to the data bus. Also, a data interface may define a physical signaling format and an address to facilitate communication with an associated device in a bus transaction. However, these are merely examples of a data interface between a data bus and a device, and embodiments of the present invention are not limited in these respects.

A “bridge” as referred to herein relates to a device coupled between data busses to transmit data between devices coupled to one bus and another bus. According to an embodiment, a bridge may be coupled between two busses for transmitting data between peripheral devices and processing resources. However, embodiments of the present invention are not limited in this respect and other applications of a bridge may be used. Also, a bridge may define a “primary” data bus which couples the bridge to a host processing system and define a “secondary” data bus which is opposite the host processing system. Such a bridge as described herein may be formed according to a peripheral components interconnection (PCI) as described in the PCI-to-PCI Bridge Architecture Specification, Rev. 1.1, Dec. 18, 1998 (hereinafter “PCI-to-PCI Bridge Specification”). However, embodiments of the present invention are not limited in this respect and a bus, bridge or bus configuration may be employed using other techniques.

A “device function” as referred to herein relates to an entity associated with a device coupled to a data bus at a data interface. The data bus may communicate with the device function through messages transmitted through the data interface. Also, multiple device functions may be associated with a single device such that a data bus may communicate with any particular device function through the transmission of signals and data through the data interface between the device and the data bus and addressed to the particular device function. However, these are merely examples of a device function and embodiments of the present invention are not limited in these respects.

“Bus enumeration” as referred to herein relates to a process or procedure including allocating resources to communicate with devices coupled to a data bus. For example, a processing system coupled to a data bus may execute a bus enumeration process to identify devices on the data bus and any device functions provided by the identified devices, and allocate processing resources to communicate with the identified devices and device functions. Such a bus enumeration process may comprise attempts to enumerate individual devices or device functions of such devices. However, this is merely an example of a bus enumeration process an embodiments of the present invention are not limited in this respect.

A “configuration transaction” as referred to herein relates to a transaction transpiring in the course of a bus enumeration process to allocate resources to communicate with the identified device or device function. For devices or device functions coupled to a PCI bus as illustrated in the PCI-to-PCI Bridge Specification, for example, an enumeration process may perform Type 0 configuration transactions to identify devices and device functions coupled to a data bus and allocate resources to communicate with the identified device or device function. Also, an enumeration process may perform a Type 1 configuration transactions to identify devices and device functions coupled to a secondary data bus behind a bridge (and allocate resources to communicate with the identified device or device function) as illustrated in Chapter 3 of the PCI-to-PCI Bridge Specification. However, these are merely examples of configuration transactions and embodiments of the present invention are not limited in these respects.

A “configuration request” as referred to herein relates to an event transpiring in a configuration transaction. For example, a configuration request may comprise a bus transaction addressed to a targeted device to interrogate the device as to the identity of the device, or the identity of a device function of the targeted device. Such a configuration request may be initiated in a configuration transaction in attempt to enumerate a targeted device or device function. For a data bus and devices formed according to the PCI-to-PCI Bridge Specification, for example, a configuration request may comprise a bus transaction to initiate a Type 0 configuration request addressed to a device coupled to the data bus, or a bus transaction to initiate a Type 1 configuration request addressed to a device coupled to a secondary data bus (e.g., behind a bridge on the data bus).

A configuration request may comprise a configuration read request addressed to a target device. In response to such a configuration read request, the targeted device may provide information such as a configuration header comprising information identifying the device or device function of the device. Alternatively, configuration request may comprise a configuration write request addressed to a target device. In response to such a configuration write request, information may be written to one or more registers of a configuration header associated with the target device. However, these are merely examples of a configuration request and embodiments of the present invention are not limited in these respects.

A device coupled to a data bus, or one or more device functions of such a device, coupled to the data bus, may be “concealed” from an enumeration procedure such that the enumeration procedure is prevented from allocating resources to communicate with the concealed device or device functions. For example, a configuration transaction initiated by an enumerating processing system and targeted a device or device function of a device may be inhibited or prevented from being completed, thereby concealing the targeted device or device function from the enumerating processing system. However, this is merely an example of how a device or device function may be concealed from an enumerating processing system, and embodiments of the present invention are not limited in this respect.

An “I/O channel” as referred to herein relates to an entity through which data may be transmitted to, or received from an external system. For example, an I/O channel may comprise a peripheral device or device function to transmit data between a data bus and a communication or storage device. However, this is merely an example of an I/O channel and embodiments of the present invention are not limited in this respect.

Briefly, an embodiment of the present invention relates to a system and method of configuring a device or device function to claim bus transactions. A host processing system may execute an enumeration procedure to configure one or more devices coupled to a data bus. At least one of a device and a device function may be concealed from the host processing system during the enumeration procedure. The concealed device or device function may be configured to claim bus transaction requests initiated by an entity independently of the host processing system.

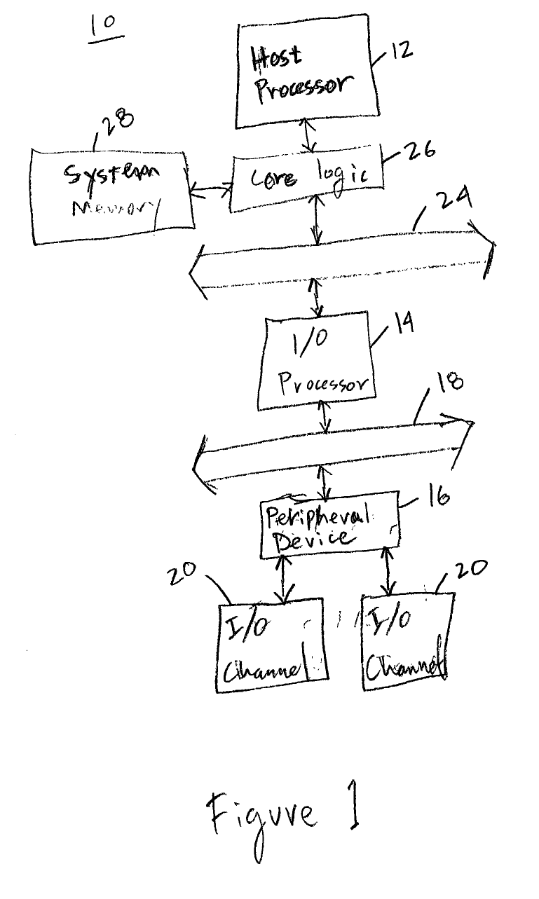

FIG. 1 shows a schematic of a processing platform 10 according to an embodiment of the present invention. A host processor 12 coupled to a system memory 28 by core logic 26 may provide a host processing system to host an operating system and application programs. An input/output (I/O) processor 14 may be coupled to the host processing system and one or more peripheral devices 16. The I/O processor 14 may host an operating system and applications to control access to an I/O channel 20 through a peripheral device 16.

A data bus 24 enables the I/O processor 14 to communicate with the host processing system and a data bus 18 enables the I/O processor 14 to communicate with the peripheral device 16 according to data bus protocols. The I/O processor 14 comprises an internal bridge defining data bus 24 as a primary bus 24 and data bus 18 as a secondary bus. According to an embodiment, the primary and secondary busses 24 and 18 may be formed according to a PCI data bus structure such as that described in the PCI Local Bus Specification, Rev. 2.3, Mar. 29, 2002 published by the PCI Special Interest Group (hereinafter the “PCI Local Bus Specification”). However, this is merely an example of a bus structure which may be employed in a data bus to transmit data between devices and embodiments of the present invention are not limited in this respect. Also, the internal bridge may be formed according to the PCI-to-PCI Bridge Specification. However, this is merely an example of how a bridge may be implemented to form primary and secondary data busses in a processing platform and embodiments of the present invention are not limited in this respect.

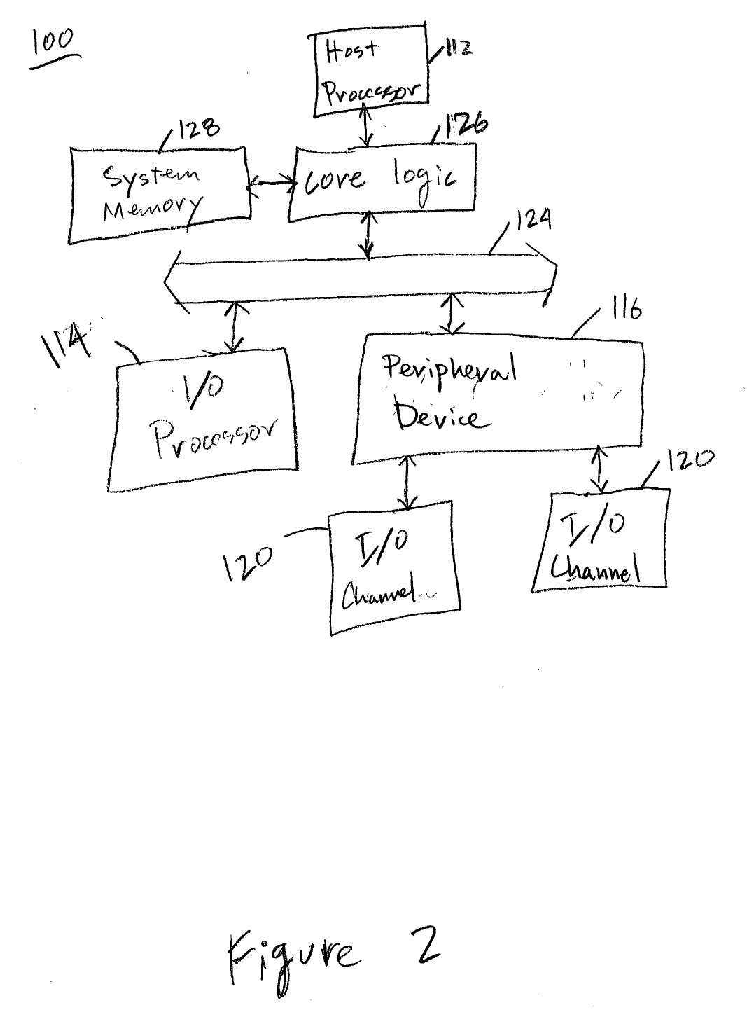

FIG. 2 shows a schematic diagram of a processing platform 100 comprising a peripheral device 116 according to an alternative embodiment of the present invention. The peripheral device 116 may comprise one or more device functions corresponding with I/O channels 120. Unlike the peripheral device 16 in the embodiment of FIG. 1, the peripheral device 116 is coupled to an I/O processor 114 and core logic 126 directly by data bus 124 independently of an intervening bridge. Accordingly, the data bus 124 may enable a host processing system comprising the host processor 112, system memory 128 and core logic 126 to enumerate the host processing system to enumerate the peripheral device 116 or device functions of the peripheral device 116 independently of an intervening bridge coupled between the data bus 124 and the peripheral device 116.

A peripheral device 16 or 116 may comprise a data interface with a data bus to transfer data between processes at the peripheral device and other devices coupled to the data bus 18. Such a data interface may comprise any one of several data interfaces with a data bus such as, for example, a device “slot” on a PCI bus defined by a bus and device number as described in the PCI-to-PCI Bridge Specification at Chapter 13. Such a device slot may be associated with a signal definition and device pinout as described in chapter 2 and section 4.2.6 of the PCI Local Bus Specification. However, these are merely examples of how a peripheral device may comprise a data interface with a data bus and embodiments of the present invention are not limited in these respects.

The host processor 12 or 112 may comprise any general central processing unit (CPU) such as a Pentium®, Xeon® or Itanium® processor sold by Intel Corporation. The core logic 26 or 126 may comprise any one of several motherboard chipsets including, for example, a memory controller hub (MCH) controlling access to system memory (such as the E7500 MCH sold by Intel® Corp.) and an I/O controller hub (ICH) controlling communication between the host processing system and one or more peripheral devices (such as the 82801CA ICH sold by Intel® Corp.). However, this is merely an example of a CPU and core logic that may be used in a host processing system, and embodiments of the present invention are not limited in this respect. The I/O processor 14 may comprise a storage I/O processor such as the 80303 or 80310 I/O processors sold by Intel Corporation. The I/O processor 114 may comprise a storage I/O processor such as the 80303, 80310 or 80321 I/O processors sold by Intel Corporation. However, these are merely examples of an I/O processor and embodiments of the present invention are not limited in these respects.

In the illustrated embodiment, the peripheral device 16 or 116 may comprise an interface according to variations of the Small Computer System Interface (SCSI) established by the National Committee for Information Technology Standards (NCITS) to enable communication through I/O channels 20 and 120. However, this is merely an example of how a peripheral device may facilitate communication with multiple I/O channels and other interfaces according to different formats such as, for example, Fibre-Channel, SSA, IBA, Serial ATA, Serial Attached SCSI (SAS) or Ethernet. The I/O channels 20 or 120 may be adapted to communicate with any one of several I/O devices such as, for example, a storage system such as a Redundant Array of Independent Disks (RAID) (not shown), a communication port, a server, a client or other storage system directly or via a switch. Such a RAID system may comprise storage devices such as magnetic storage disks or other mass data storage media.

The peripheral device 16 or 116 may comprise one or more device functions which may be adapted to communicate through respective I/O channels 20 or 120 where access to each I/O channel is controlled by an associated device function. However, this is merely an example of how a peripheral device may implement multiple device functions to provide multiple I/O channels and embodiments of the present invention are not limited in this respect. For example, a device (e.g., peripheral device 16 or 116) may be coupled to a slot on a PCI data bus and may comprise up to eight device functions (device functions 0 through 7) such that bus transactions may be individually addressed to device functions through the single slot on the PCI data bus. Again, these are merely examples of how a peripheral device may implement multiple device functions to provide multiple I/O channels and embodiments of the present invention are not limited in this respect.

In other embodiments, an I/O processor may be coupled to a host processing system as an “endpoint” device through a “root complex” as provided in a PCI Express environment described in the PCI Express Base Specification Rev. 1.0, Jul. 16, 2002 (hereinafter the “PCI Express Specification”). For example, the I/O processor may be coupled to a downstream port of a “switch” while communicating with peripheral devices coupled to other downstream ports of the switch. Alternatively, the I/O processor may be coupled to peripheral devices by a data bus formed according to the PCI Local Bus Specification or the PCI-X 2.0 Protocol Specification. In another example, the I/O processor may be coupled to an upstream port of a second switch to communicate with peripheral devices coupled to downstream ports of the second switch. However, these are merely examples of how an I/O processor may be coupled to communicate with a host processing system and peripheral devices in a PCI Express environment, and embodiments of the present invention are not limited in these respects.

According to the embodiments of FIGS. 1 and 2, an enumeration procedure may be executed (e.g., by the host processor 12 or I/O processor 4 in the embodiment of FIG. 1, or by the host processor 112 or I/O processor 114 in the embodiment of FIG. 2) to configure resources to communicate with one or more devices coupled to a data bus or device functions of such devices. An I/O processor (e.g., I/O processor 14 or 114) may comprise logic to conceal one or more devices coupled to a data bus from an enumeration procedure executed at a host processing system. Additionally, the I/O processor may conceal individual device functions of a peripheral device from such enumeration procedure while allowing other unconcealed devices of the peripheral device to be configured by the enumeration procedure.

In an embodiment in which a device is coupled to a PCI bus, for example, the I/O processor may prevent a host processing system from configuring resources to communicate with the peripheral device in an enumeration procedure by controlling an “IDSEL” signal (see, e.g., Sections 3.2.2.3.4 and 3.2.2.3.5 of the PCI Local Bus Specification) on a data interface coupling the data bus and the peripheral device. Such logic to control the IDSEL signal for concealing a device may be implemented in, for example, the I/O processor or discrete logic as described in U.S. patent application Ser. No. 09/472,502 filed on Dec. 27, 1999, assigned to Intel Corporation and incorporated herein by reference. For example, the I/O processor may comprise logic to assert an optional PCI signal “TMS” to inhibit the IDSEL signal on the data interface to a peripheral device (e.g., peripheral 16 or 116). However, this is merely an example of how a first processing system may inhibit a second processing system from configuring a device on a data bus in an enumeration procedure, and embodiments of the present invention are not limited in this respect.

According to an embodiment, the peripheral device may comprise more than one device function (e.g., a distinct device function to control access to an associated I/O channel 20 or 120). The I/O processor may also comprise logic to conceal one or more device functions of the device (allowing a host processing system to configure resources for communicating with remaining unconcealed device functions). In an embodiment in which a peripheral device is coupled to a PCI bus, for example, the I/O processor may conceal individual device functions from a host processing system using techniques described in U.S. patent appl. Ser. No. 09/954,129, filed on Sep. 14, 2001, assigned to Intel Corporation, and incorporated herein by reference.

According to an embodiment, the I/O processor may configure a concealed device or device function to communicate with the I/O processor independently of a host processing system. In one embodiment, a host processing system may execute a first enumeration procedure to configure all unconcealed peripheral devices and any unconcealed device functions. The I/O processor may then execute a second enumeration procedure to configure any concealed devices or device functions to communicate with the I/O processor independently of the host processing system.

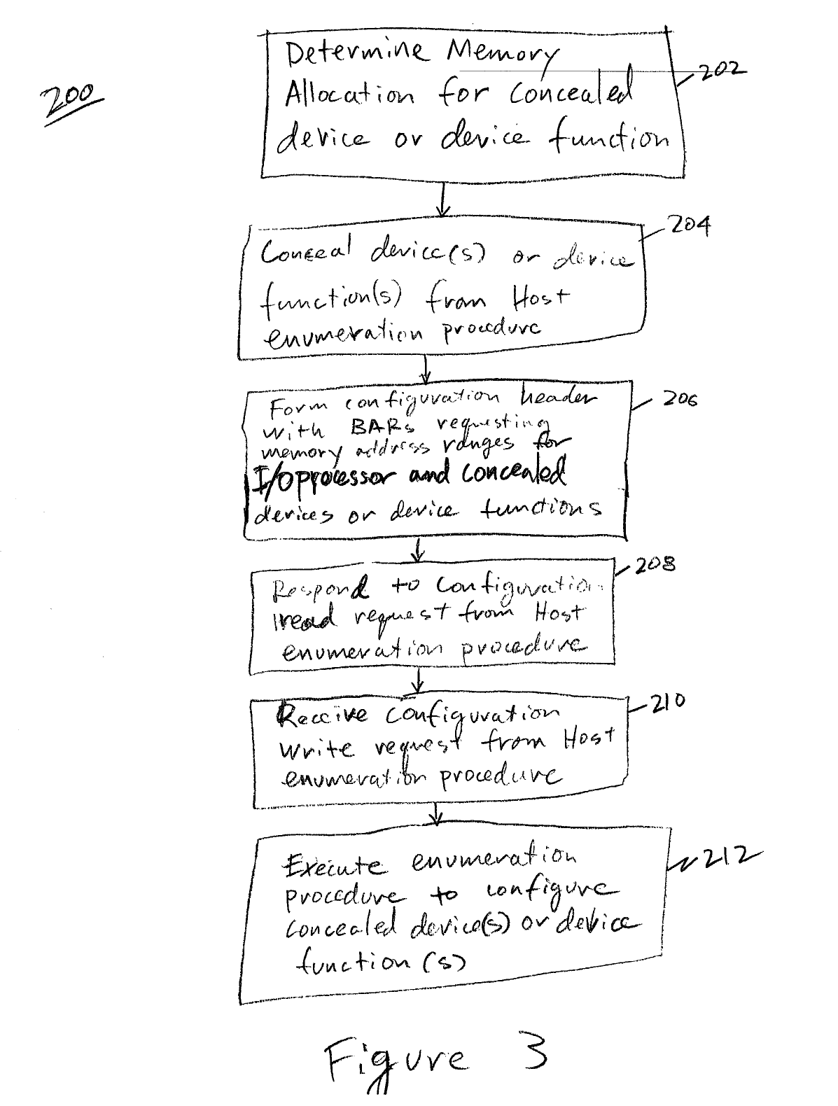

FIG. 3 shows flow diagram illustrating logic at an I/O processor (e.g., the I/O processor 14 or 114) to configure a concealed device or device function according to an embodiment. In the presently illustrated embodiment, the I/O processor may configure concealed devices or device functions to communicate with the I/O processor according to a data bus protocol as that described in the PCI Local Bus Specification. For example, the I/O processor may configure the concealed devices or device functions to respond to memory read or memory write commands as described in Chapter 3 of the PCI Local Bus Specification. To enable the concealed devices or device functions to respond to such memory read or memory write requests, the I/O processor may configure the concealed devices or device functions by initializing local drivers and allocating resources such as memory address ranges indicated in Base Address registers (BARs).

At block 202, the I/O processor may determine memory addressing resources to be allocated to the concealed devices or device functions. The I/O processor may execute firmware (e.g., in response to a reset event) that includes (or locally retrieves) information identifying each device or device function that is to be concealed, identifying the configuration address of the device or device function, and quantifying memory addressing resources to be allocated to the device or device function. Such memory addressing resources to be allocated to a concealed device or device function may include a range of memory addresses defining memory read and memory write requests to be claimed by the device or device function.

As described below, the I/O processor at block 212 may initiate an enumeration procedure to configure the concealed devices or device functions following an initial enumeration procedure controlled by a host processing system. In an alternative to determining a configuration address of the concealed device or device function from firmware information, the I/O processor may perform an initial bus scan (e.g., using configuration read requests) of the devices on a data bus to receive a configuration address prior to the enumeration procedure controlled by the host processing system. The I/O processor may then associate device ID information (from the configuration headers of the scanned devices) with device ID information (of the concealed device or device function) programmed in the I/O processor firmware to determine the configuration address of the concealed device or device function.

During an enumeration procedure executed by the host processing system, the host processing system may attempt to enumerate each device coupled to the data buses (or individual functions of the device) by transmitting configuration read requests addressed to configuration address of the device. At block 204, the I/O processor may conceal the devices or device functions (identified at block 202) by inhibiting responses to configuration read requests from the host processing system addressed to the devices or device functions (e.g., as indicated in U.S. patent application Ser. Nos. 09/472,502 and 09/954,129).

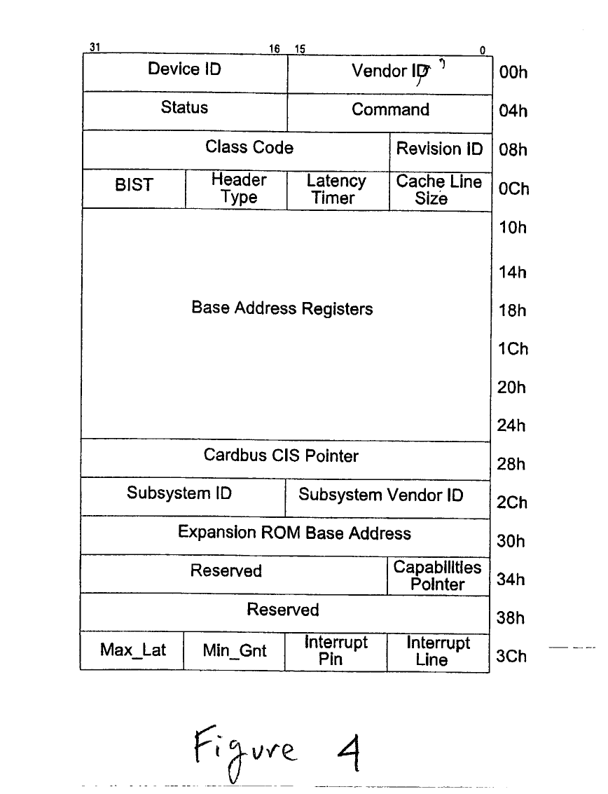

At block 206, the I/O processor may construct a configuration header as defined in Chapter 6 of the PCI Local Bus Specification to be provided to the host processing system in response to a configuration read request addressed to the I/O processor. The configuration header may be formatted as shown in FIG. 4. In particular, the I/O processor may set BARs in the configuration header to indicate memory addressing resources to be allocated to the I/O processor and to each concealed device and device function. For example, the I/O processor may set the BARs in the configuration header to request (from the host processing system) a single range of memory addresses to be allocated among the I/O processor and the concealed devices and device functions. Alternatively, the I/O processor may set the BARs in the configuration header to request a first range of memory addresses to be allocated to the I/O processor and a second range of memory addresses to be allocated to one or among more than one concealed devices or device functions. In yet another embodiment, the I/O processor may set the BARs in the configuration header to request a range of memory addresses to be allocated to the I/O processor and an additional range of memory address to be allocated to each concealed device or device function. However, these are merely examples of how a configuration header may be set to request memory addressing resources to be allocated among multiple entities and embodiments of the present invention are not limited in these respects.

At block 208, the I/O processor may respond to a configuration read request from the host processing system enumeration procedure by providing the configuration header with the BARs (as formed at block 206) indicating memory address ranges to be allocated to the I/O processor and the concealed devices or device functions. Following the configuration read bus transaction, the host processing system may initiate a configuration write transaction to set the BARs in the configuration header associated with the I/O processor, indicating memory address ranges allocated to the I/O processor and the concealed devices or device functions as described at section 6.2.5 of the PCI Local Bus Specification.

At block 210, the I/O processor may receive a configuration write request from the host processing system enumeration procedure to set BARs in the configuration header of the I/O processor. In response to receipt of the configuration write request, these BARs may be set to define the specific memory address ranges that the host processing system has allocated to the I/O processor. Accordingly, these BARs may reflect memory address ranges defining bus transactions to be claimed by the I/O processor, and memory address ranges defining bus transactions to be claimed by the concealed devices or device functions.

At block 212, the I/O processor executes an enumeration procedure to configure the concealed devices or device functions to communicate with the I/O processor independently of the host processing system. The I/O processor may initiate a configuration read request (either before or after the enumeration procedure controlled by the host processing system) to each of the concealed devices or device functions. Following responses to the configuration read requests from the concealed devices or device functions, the I/O processor may 1) initialize drivers for execution on the I/O processor for communication with the concealed devices or device drivers and 2) initiate configuration write bus transactions to allocate a memory address range to the concealed device or device function. Such a configuration write bus transaction addressed to a concealed device or device function may set BAR registers in a configuration header associated with the device or device function to define the allocated memory address range allocated to the concealed device or device function as described in Section 6.2.5 of the PCI Local Bus Specification.

The memory address range allocated to the concealed device or device function may comprise a range of memory addresses which was allocated to the I/O processor from the host processing system at block 210. For example, the memory address range allocated to the concealed device or device function may comprise a subset of memory addresses from a second memory address range allocated to the I/O processor (e.g., the first memory address allocated to the I/O processor is to configure the I/O processor to communicate with the host processing system while the second memory address range is to be allocated among concealed devices or device functions). Alternatively, the memory address range allocated to the concealed device or device function may comprise an entire address allocated to the I/O processor (e.g., a memory address range is allocated to the I/O processor to configure the I/O processor in addition to a memory address range for each concealed device or device function).

Following the enumeration procedure initiated by the I/O processor at block 212, the I/O processor may address memory read and memory write requests to the configured and concealed devices and device functions independently of the host processing system. Such a memory read or memory write request may be addressed to a concealed device or device function with a memory address that is within a memory address range allocated to the device or device function as indicated in the BARs associated with the device or device function. For example, the device or device function may claim such memory read or memory write requests using memory space decoding as described in section 3.2.2.2 of the PCI Local Bus Specification.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
executing an enumeration procedure at a host processing system to configure one or more devices coupled to a data bus;
concealing at least one of a device and a device function from the host processing system during the enumeration procedure, the at least one of a device and a device function coupled to the data bus; and
configuring the at least one of a device and device function to claim bus transaction requests on the data bus, the bus transaction requests being initiated independently of the host processing system.

2. The method of claim 1, wherein configuring the at least one of a device and a device function to claim bus transaction requests further comprises setting one or more base address registers associated with the at least one of a device and a device function.

3. The method of claim 1, wherein configuring the at least one of a device and a device function to claim bus transaction requests further comprises executing an enumeration procedure at an I/O processor to configure the at least one of a device and a device function to claim bus transaction requests on the data bus.

4. The method of claim 3, the method further comprising:
initiating data bus commands at the I/O processor; and
claiming the data bus commands at the at least one of a device and a device function.

5. The method of claim 1, wherein concealing the at least one of device and a device function from the host processing system during the enumeration procedure comprises inhibiting an IDSEL signal on the data bus associated with the at least one of device and device function.

6. The method of claim 1, wherein executing an enumeration procedure at a host processing system further comprises allocating one or more memory address ranges to an I/O processor coupled to the data bus, and wherein the method further comprises executing an enumeration procedure at the I/O processor to allocate a range of memory addresses to the at least one of a concealed device and device function from among the one or more memory address ranges allocated to the I/O processor.

7. An article comprising:
a storage medium comprising machine-readable instructions stored thereon to:
conceal at least one of a device and a device function coupled to a data bus from a host processing system during an enumeration procedure initiated by the host processing system; and
configure the at least one of a device and a device function to claim bus transaction requests on the data bus, the bus transaction requests being initiated independently of the host processing system.

8. The article of claim 6, wherein the storage medium further comprises machine-readable instructions stored thereon to set one or more base address registers associated with the at least one of a device and a device function.

9. The article of claim 6, wherein storage medium further comprises machine-readable instructions stored thereon to execute an enumeration procedure to configure the at least one of a device and device function to claim bus transaction requests on the data bus.

10. The article of claim 6, wherein storage medium further comprises machine-readable instructions stored thereon to inhibit an IDSEL signal on the data bus associated with the at least one of a device and a device function.

11. The article of claim 6, wherein the storage medium further comprises machine-readable instructions stored thereon to execute a second enumeration procedure to allocate a range of memory addresses to the at least one of a concealed device and device function from among one or more memory address ranges allocated to a device during the enumeration procedure initiated by the host processing system.

12. An I/O processor comprising:
logic to conceal at least one of a device and a device function coupled to a data bus from a host processing system during an enumeration procedure controlled by the host processing system; and
logic to configure the at least one of a device and device function to claim bus transaction requests on the data bus, the bus transaction requests being initiated independently of the host processing system.

13. The I/O processor of claim 12, the I/O processor further comprising logic to set one or more base address registers associated with the at least one of a device and device function.

14. The I/O processor of claim 12, the I/O processor further comprising logic to execute an enumeration procedure to configure the at least one of a device and device function to claim bus transaction requests on the data bus.

15. The I/O processor of claim 12, the I/O processor further comprising logic to inhibit an IDSEL signal on the data bus associated with the I/O controller to conceal the I/O controller during the enumeration procedure controlled by the host processing system.

16. The I/O processor of claim 12, wherein the I/O processor further comprises logic to execute a second enumeration procedure to allocate a range of memory addresses to the at least one of a concealed device and device function from among one or more memory address ranges allocated to the I/O processor device during the enumeration procedure controlled by the host processing system.

17. A system comprising:
a host processing system;
a device coupled to the host processing system through a data bus; and
an I/O processor comprising:
logic to conceal one of the device and a device function of the device from the host processing system during an enumeration procedure controlled by the host processing system; and
logic to configure the concealed one of the device and device function to claim bus transaction requests on the data bus, the bus transactions being initiated independently of the host processing system.

18. The system of claim 17, wherein the I/O processor further comprises a bridge coupled to the host processing system through a primary data bus, and coupled to the device through a secondary data bus.

19. The system of claim 17, wherein the system further comprises a magnetic storage medium coupled to the device to store data according to a data storage format.

20. The system of claim 17, wherein the device comprises logic to transmit or receive data according to a serial ATA format.

21. The system of claim 17, wherein the device comprises logic to transmit or receive data according to a SCSI format.

22. The system of claim 17, wherein the device further comprises logic to transmit or receive data according to a SAS format.

23. The system of claim 17, wherein the I/O processor further comprises logic to set one or more base address registers associated with the at least one of a device and device function.

24. The system of claim 17, wherein the I/O processor further comprises logic to execute an enumeration procedure to configure the at least one of a device and device function to claim bus transaction requests on the data bus.

25. The system of claim 17, wherein the I/O processor further comprises logic to inhibit an IDSEL signal on the data bus associated with the I/O controller to conceal the I/O controller during the enumeration procedure controlled by the host processing system.

26. The system of claim 17, wherein the I/O processor further comprises logic to execute a second enumeration procedure to allocate a range of memory addresses to the at least one of a concealed device and device function from among one or more memory address ranges allocated to the I/O processor during the enumeration procedure controlled by the host processing system.

27. A method comprising:
executing a first enumeration procedure controlled at a host processing system to configure an I/O processor coupled to the host processing system through a data bus, the first enumeration procedure comprising allocating one or more memory address ranges allocated to the I/O processor; and
executing a second enumeration procedure controlled at the I/O processor to configure at least one of a device and a device function to communicate with the I/O processor, the second enumeration procedure comprising allocating a range of memory addresses to the at least one a device and device function from among the one or more memory address ranges allocated to the I/O processor.

28. The method of claim 27, the method further comprising concealing the at least one of a device and a device function from the host processing system during the first enumeration procedure.

29. The method of claim 27, wherein executing the second enumeration procedure further comprises configuring the at least one of a device and device function to claim bus transaction requests on a data bus, the bus transaction requests being initiated independently of the host processing system.

30. The method of claim 27, wherein allocating a range of memory addresses to the at least one a device and device function further comprises setting one or more base address registers in a configuration header associated with the at least one of a device and device function.

31. An I/O processor comprising:
logic to request an allocation of one or more memory address ranges from a host processing system in response to a first enumeration procedure controlled by the host processing system; and
logic to initiate a second enumeration procedure to configure at least one of a device and a device function to communicate with the I/O processor, the second enumeration procedure comprising an allocation of a range of memory addresses to the at least one a device and device function from among the requested one or more memory address ranges.

32. The I/O processor of claim 31, the I/O processor further comprising logic to conceal the at least one of a device and a device function from the host processing system during the first enumeration procedure.

33. The I/O processor of claim 31, wherein the second enumeration procedure comprises configuring the at least one of a device and device function to claim bus transaction requests on a data bus, the bus transaction requests being initiated independently of the host processing system.

34. The I/O processor of claim 31, wherein the allocation of a range of memory addresses to the at least one a device and device function comprises setting one or more base address registers in a configuration header associated with the at least one of a device and device function.

35. An article comprising:
a storage medium comprising machine-readable instructions stored there on to:
request an allocation of one or more memory address ranges from a host processing system in response to a first enumeration procedure controlled by the host processing system; and
initiate a second enumeration procedure to configure at least one of a device and a device function to communicate with an I/O processor, the second enumeration procedure comprising an allocation of a range of memory addresses to the at least one a device and device function from among the requested one or more memory address ranges.

36. The article of claim 35, wherein the storage medium further comprises machine-readable instructions stored thereon to conceal the at least one of a device and a device function from the host processing system during the first enumeration procedure.

37. The article of claim 35, wherein the storage medium further comprises machine-readable instructions stored thereon to configure the at least one of a device and device function to claim bus transaction requests on the data bus, the bus transaction requests being initiated independently of the host processing system.

38. The article of claim 37, wherein the storage medium further comprises machine-readable instructions stored thereon to set one or more base address registers in a configuration header associated with the at least one of a device and device function.

39. A method comprising:
requesting an allocation of one or more memory address ranges from a host processing system in response to a first enumeration procedure controlled by the host processing system; and
initiating a second enumeration procedure to configure at least one of a device and a device function to communicate with an I/O processor, the second enumeration procedure comprising an allocation of a range of memory addresses to the at least one a device and device function from among the requested one or more memory address ranges.
